(19) United States
(12) Patent Application Publication
(10) Pub. No.: US 2019/0114683 A1
(43) Pub. Date: Apr. 18, 2019

(54) DYNAMICALLY DETERMINATION AND ACCEPTANCE OF DISCOUNT RATE FOR PENDING INVOICES

(71) Applicant: MINIONS VENTURES PVT. LTD., Bangalore (IN)

(72) Inventors: Devang Mundhra, Bangalore (IN); Manish Kumar, Bangalore (IN); Anurag Jain, Bangalore (IN); Hemant Kumar Joshi, Bangalore (IN)

(21) Appl. No.: 16/162,005

(22) Filed: Oct. 16, 2018

(30) Foreign Application Priority Data
Oct. 16, 2017 (IN) 201741036710

(51) Int. Cl. G06Q 30/04; G06Q 30/02; G06Q 30/08

(52) U.S. Cl. CPC G06Q 30/04; G06Q 30/08; G06Q 30/0207

(57) ABSTRACT

A system and method to determine and accept discount for a plurality of invoices, has been described. Initially, a vendor request is received to initiate a bidding session to place a bid for earlier processing of the plurality of pending invoices by a consumer. Based on the received vendor request, a discount is determined for each of the plurality of invoices based on at least one of a vendor information, the consumer information, and a bidding pattern in previous session. Next the plurality of invoices and the determined discount corresponding to the plurality of pending invoices are displayed to the consumer. Finally, one or more pending invoices from the plurality of pending invoices are auto-selected based on at least one of the vendor information, the consumer information, and the bidding session specific information.

### CROSS-REFERENCE TO RELATED APPLICATIONS

The embodiments herein claim the priority of the Indian Provisional Patent Application No. 201741036710 filed on Oct. 16, 2017 with the title “COMPUTER IMPLEMENTED SYSTEM AND METHOD FOR DYNAMICALLY DETERMINATION OF DISCOUNT RATE”, and the contents of which is included entirely as reference herein.

### TECHNICAL FIELD

The present disclosure relates to discounting of pending invoices. Particularly, the present disclosure relates to determining a dynamic discount rate to be applied to a pending invoice.

### BACKGROUND

Typically, a supplier (vendors) of goods and/or services is paid for selling goods or rendering services, only after an invoice detailing the costing of the sold goods/rendered services is presented to the corresponding consumer. A consumer typically processes the submitted invoice and releases the corresponding payment to the vendor in-line with the pre-agreed terms and conditions of payment and typically after expiry of a predetermined number of days from the day on which the invoice was submitted. Typically, the terms and conditions of payment also specify the number of days after the expiry of which the payment pending against an invoice would be released to the vendor.

Given the inadvertent delays associated with the process of clearing an invoice at the consumer's end, the vendor is typically compelled to offer a fixed cash discount to the consumer—with the quantum of cash discount being decided by the consumer—irrespective of the number of days remaining before the actual payment is made, and irrespective of currently available discount rates. Alternatively, the vendor could offer a dynamic discount to the consumer, with the dynamic discount being calculated based on the number of days remaining before the actual payment and further based on the financial positioning of the vendor. Alternatively, the vendor could also place a bid for a discount rate to be applied onto a pending invoice and avail the payment minus discounts if the bid is successfully accepted, provided the consumer allows for such a bid to be placed and provided the consumer electronically processes the pending invoices. Alternatively, the vendor could also negotiate with the consumer, preferably on an ad-hoc basis, the terms and conditions governing the payment and subsequently secure an early payment.

However, the disadvantages associated with following any of the aforementioned alternatives are that the vendor nevertheless has to wait until the invoices are approved by the vendor for processing. Typically, the process of invoice approval takes up anywhere between a couple of days to a week. Further, while some of the aforementioned alternative scenarios do not enable the vendor to highlight his urgency for payment, the alternative scenarios that enable the vendor to highlight his urgency for receiving the payment by the way of providing bids for discount, such alternative scenarios do not enable the vendor to gauge an appropriate discount amount that is compatible with the approval policies of the consumer and is better than the bids generated by competitors. Another disadvantage associated with the aforementioned scenarios is that when a consumer receives a large number of bids from multiple vendors for discounting the invoices, the consumer might face a dilemma in terms of accepting some of the bids and rejecting the remaining bids, and might not be able to effectively decide upon the bids to be accepted and the bids to be rejected.

Therefore, in view of the drawbacks described herein above, there has been felt a need for a system and method that makes it easier for vendors to provide a dynamic discount on the pending invoices taking into consideration the need/urgency associated with the pending invoice, the bids generated by other vendors, number of days pending before the payment and financial profile of the vendors. There is also felt a need for a system and method that envisages comparatively faster processing of pending invoices. Further, there has also been felt a need for a system and method that enables consumers to make informed decisions about the invoices to be processed for early payment.

### OBJECT OF THE INVENTION

An object of the present disclosure is to provide a system and method that enables vendors to offer a dynamic discount on the pending invoices, based on their (vendors') financial needs and requirements.

Yet another object of the present disclosure is to provide a system and method that enables vendors to offer a dynamic discount on the pending invoices based on the number of days remaining for payment and the competing bids generated by other vendors.

Still a further object of the present disclosure is to provide a system and method that allows for a comparatively faster processing of invoices.

One more object of the present disclosure is to provide a system and method that enables consumers to selectively approve the pending invoices based on the availability of funds, the relationship between the consumer and each of the vendors, and the expected returns.

Yet another object of the present disclosure is to envisage a system and method that enables consumers to consider individual bids and make informed choices about accepting the bids, based on the discounts offered by each of the bids.

Still a further object of the present disclosure is to provide a system and method that provides recommendations/suggestions to consumers about accepting or rejecting each bid based on the financial needs specified by the vendors, and bidding patterns of the vendors.

Yet another object of the present disclosure is to envisage a system and method that takes into consideration the financial requirements of the vendor and the urgency associated with each of the invoices/bids submitted by the vendor, to decide upon the appropriate discount amount to be offered to a consumer as a bid for prompting the consumer to offer an early payment.

### SUMMARY

The present disclosure envisages a system and method that makes it possible for vendors to provide a dynamic discount on the pending invoices, based on their (vendors') financial needs and requirements, and further based on the number of days remaining for payment and the competing bids generated by other vendors. The system and method also provide for comparatively faster processing of invoices. Further, the system and method also enable consumers to selectively approve the pending invoices based on the availability of funds, the relationship between the consumer and each of the vendors, and the expected returns (discount rate offered by each of the vendors).

In accordance with the present disclosure, the vendor is provided with the option of securing an early payment in return for offering a discount—which is calculated dynamically based on a plurality of predetermined parameters—to the consumer. The system and method enable consumers to consider individual bids and make informed choices about accepting the bids, based on the discounts offered by each of the bids.

In accordance with the present disclosure, the system and method envisages margin-based discounts in return for early settlement of pending invoices. Further, the system provides recommendations/suggestions to consumers about accepting or rejecting each the bids, based on the financial needs specified by the vendors, bidding patterns of the vendors, and the like. Further, the system (and method) takes into consideration the financial requirements of the vendor and the urgency associated with each of the invoices/bids submitted by the vendor, to decide upon the appropriate discount amount to be offered to a consumer as a bid for prompting the consumer to offer an early payment.

The system (and method), in accordance with the present disclosure, compares a bid submitted by a specific vendor with the bids submitted by other vendors, and ensures that the bids pertinent to invoices which are bound by most urgent financial requirements are fulfilled. Further, the system (and method) facilitates a margin-based invoice discounting for invoices that are yet to be approved, by the way of calculating a margin based on a threshold pre-set by the consumer and the historical approval statistics corresponding to the consumer.

In accordance with the present disclosure, the system implements a smart bid determination procedure. The smart bid determination procedure attempts maximization of corporate yield on each invoice by producing an appropriate discounting rate for the vendor. The smart bid determination procedure takes into consideration a plurality of variables to arrive at the appropriate discounting rate. The smart bid determination procedure incorporates pattern recognition abilities and is configured to learn from and make informed data driven predictions or decisions to maximize the economic value for the stakeholders.

In accordance with the present disclosure, the system further implements a bid session creation procedure that automates the process of session creation for the enterprises. The bid session creation procedure takes into consideration a number of variables and then decides on frequency of sessions, the selection of invoices for a session, the base rate and funds to allocate. The bid session creation procedure recognises the pattern of bidding, seasonality in demand and vendor behaviour over the time to predict the returns on next sessions and thus maximising the probability to get higher returns.

In accordance with the present disclosure, the system further implements a bid approval procedure. The bid approval procedure automates the process of selective approval of invoices with high bid of discount offers. The bid approval procedure ensures that the enterprise can maximize yield by doing early payment on the other hand there should be fair distribution of funds so that only few vendors do not take advantage by predatory discount bids.

### BRIEF DESCRIPTION OF ACCOMPANYING DRAWINGS

FIG. 1A, FIG. 1B and FIG. 1C in combination describe a flowchart illustrating the step involved in the method for dynamically determining a discount rate to be applied to a pending invoice, in accordance with the present disclosure

FIG. 2 depicts a generalized example of a suitable computing system 200 in which the described innovations may be implemented.

### DETAILED DESCRIPTION

To obviate the drawbacks discussed hitherto, the present disclosure envisages a system and method that makes it possible for vendors to provide a dynamic discount on the pending invoices, based on their (vendors') financial needs and requirements, and further based on the number of days remaining for payment and the competing bids generated by other vendors. The system and method also provides for comparatively faster processing of invoices. Further, the system and method also enable consumers to selectively approve the pending invoices based on the availability of funds, the relationship between the consumer and each of the vendors, and the expected returns (discount rate offered by each of the vendors).

In accordance with the present disclosure, the vendor is provided with the option of securing an early payment in return for offering a discount—which is calculated dynamically based on a plurality of predetermined parameters—to the consumer. The system and method enable consumers to consider individual bids and make informed choices about accepting the bids, based on the discounts offered by each of the bids.

In accordance with the present disclosure, the system and method envisages margin-based discounts in return for early settlement of pending invoices. Further, the system provides recommendations/suggestions to consumers about accepting or rejecting each the bids, based on the financial needs specified by the vendors, bidding patterns of the vendors, and the like. Further, the system takes into consideration the financial requirements of the vendor and the urgency associated with each of the invoices/bids submitted by the vendor, to decide upon the appropriate discount amount to be offered to a consumer as a bid for prompting the consumer to offer an early payment.

The system (and method), in accordance with the present disclosure, compares a bid submitted by a specific vendor with the bids submitted by other vendors, and ensures that the bids pertinent to invoices which are bound by most urgent financial requirements are fulfilled. Further, the system (and method) facilitates a margin-based invoice discounting for invoices that are yet to be approved, by the way of calculating a margin based on a threshold pre-set by the consumer and the historical approval statistics corresponding to the consumer.

In accordance with the present disclosure, the system implements a smart bid determination procedure. The smart bid determination procedure attempts maximization of corporate yield on each invoice by producing an appropriate discounting rate for the vendor. The smart bid determination procedure takes into consideration a plurality of variables to arrive at the appropriate discounting rate. The smart bid determination procedure incorporates pattern recognition abilities and is configured to learn from and make informed data driven predictions or decisions to maximize the economic value for the stakeholders. The variables considered by the smart bid determination procedure for determining the discount rate include the following:
Urgency of the need—Urgency of the need is characterised by the time period in which the vendor requires the funds tied in his unpaid invoices and records his perception of the need. The need could be urgent, moderate or low urgency. This variable helps in deciding how much worth of invoices should be placed at what discount rate. It depicts the aggressiveness of the vendor to get the funds from the enterprise.
Vendor requirement—This variable quantifies the requirement of funds by the vendor and can impact the final discounting rate drastically. The underlying assumption for the impact of this variable is that every enterprise will have a limited pool of surplus funds which can be deployed for Early payments. Theoretically, higher the value of funds required by the vendor, greater will be the discounting rate to be offered to the enterprise.
Enterprise liquidity—Enterprise liquidity plays an important role in the final input as the ability of the corporate to serve the funding needs of the vendor is determined by this variable. Ideally, higher the pot available to be disbursed, higher will be the number of vendors who can reap the benefits of early payments.
Enterprise Base Rate (including differential rates based on type, tier, priority)—This variable/s has the capacity to materially impact the final discounting rate as it corroborates the minimum rate expectations of the enterprise. A lower discounting rate might not give enough value to the corporate and will discourage him from accepting the bids.
Historical Bidding patterns of other vendors—This is a derived function and it requires data analytics on the historical data of successful as well as failed bids for different vendors to arrive at a pattern for each vendor which can be further used to optimize the value provided by smart bid determination procedure. The bid rates by other vendors are not considered in current session to avoid unfair advantage to the late bidder.
Total values of invoices in the session—Each vendor who needs early payment bids for his invoices and expects the payment from the Enterprise. Given the total value of invoices in a particular session might be different from the available surplus with the corporate, it becomes an important variable in determining the final discounting rate.
Payment period of invoices—Discounting rate expected by the enterprise has a direct correlation with the tenure of the invoice as higher tenure invoices tend to have higher discounting rates (as present value of funds is higher for vendors). If a vendor is bidding for higher tenure invoices, there is a higher chance that the discounting rates to be offered will be more aggressive.
Historical data of trend and fulfilment—This requires pattern recognition abilities and mathematical optimization techniques by the system to arrive at certain values that are used as input in the smart bid determination procedure. This helps in predicting the fund allocation by enterprise and subsequently calculating the discount rate accordingly.
Historical data of vendor invoices—This will help in assessing the growth in vendor's business and the propensity of providing discount on the unpaid invoices. The growth rate will affect the urgency of need of capital and affect the discount rate.
Available market rate for ceiling—This will be used to keep upper limit in discount rate calculation. It is based on interest rate at which immediate capital can be acquired from the market and is influenced by the MCLR, LIBOR, or other market accepted rates.
Profit margin for the vendor—Higher the profit margin in vendor's business, higher the return on capital which leads to higher discount rates. Such vendors will have a higher opportunity cost for their funds and will tend to roll the money more number of times which will push them to bid aggressively for Early payments.
A multiplier factor to the base rate (or ceiling rates)—This complicated variable takes into account factors like seasonality of demand, macroeconomic variables (e.g. demonetization, inflation, and the like.) to arrive at certain predictions which can affect the discounting rate materially.
Enterprise allocation strategy—Early payments at scale through the use of technology is a recent phenomenon and might take some time for Enterprises to acclimatize which means that their allocation strategy will also be impacted by the success of other Corporates. It has a subjective impact on their decision to use this as a tool for deploying their surplus funds.

In accordance with the present disclosure, the system further implements a bid session creation procedure that automates the process of session creation for the enterprises. The bid session creation procedure takes into account a number of variables and then decides on frequency of sessions, the selection of invoices for a session, the base rate and funds to allocate. The bid session creation procedure recognises the pattern of bidding, seasonality in demand and vendor behavior over the time to predict the returns on next sessions and thus maximising the probability to get higher returns. The variables considered by the bid session creation procedure includes the following:
Number of Invoices: It is considered that there are sufficient number of invoices available to start a bidding session so that there is good competition to get early payments.
Monthly Liquidity: Monthly liquidity of the enterprise used to know the number of invoices for which early payment can be made. This liquidity is then divided into different sessions.
Bidding Trend: There are trends in discount rates offered by different vendors at different time of month based on their business cycles. So picking higher invoices of the vendors when they are expected to offer more discount will help in maximizing returns.
Seasonality in Average Yield: Based on seasonality trend of average yield at different time of month, the fund allocation is changed so that bigger portion of fund earns higher yield.
Seasonality in vendor participation: Based on seasonality in vendor participation, the fund allocation on different session can be changed so that competition remains fair.
Payment Cycle of Enterprise: The invoice selection is based on the payment cycle of the enterprise. Smaller the cycle, earlier the invoice need to be part of session. For longer cycles, same invoice can be repeated in multiple sessions.
Vendor Selection: For each session there should be right mix of high margin vendors and low margin vendors to keep the yield consistent across the month.
Distribution of Vendor Type: Few vendor types have higher margin so they offer more discount and vice-e-versa.
MCLR: This impacts the expected base rate from the session.
External Factors: This complicated variable takes into account factors like seasonality of demand, macroeconomic variables (e.g. demonetization, inflation, etc.) to arrive at certain predictions which can affect the discounting rate materially.

In accordance with the present disclosure, the system further implements a bid approval procedure. The bid approval procedure automates the process of selective approval of invoices with high bid of discount offers. The bid approval procedure ensures that the enterprise can maximize yield by doing early payment on the other hand there should be fair distribution of funds so that only few vendors do not take advantage by predatory discount bids. To achieve this, the bid approval procedure considers the number of variables and pattern recognition. This algorithm will take into consideration all the variables defined in bid creation procedure and in addition to that the following variables:
Base Rate: It the base rate expectation from the enterprise. It can be specified at the session level or at the vendor type level In case enterprise is using session creation procedure, then base rate is the output of session creation procedure.
Session Liquidity: This is the amount which enterprise is willing to liquidate in this session. This again can be the output of session creation procedure. Also bid approval procedure can increase the fund allocation if it finds that there is higher return invoices available.
Deviation from historical average rate per vendor: This will be used to judge the urgency of need of the vendors.
Urgency distribution: This will be the urgency factor where vendors have used smart bid and explicitly mentioned their urgency of need. This will be considered to ensure that extremely urgent needs are fulfilled.
Vendor Age: This will be factored so that newly added vendors are not ignored due to absence of historical trend.
Option: This option means that the vendor has alternate way to discount invoices apart from being funded by enterprise. So such vendors with high urgency and low discount can be de-prioritised to ensure higher return to enterprise.
Vendor Type level average rate vs vendor rate: This variable will factor any business segment level change in market dynamics or seasonality factors which might have impacted the discount bid.
Vendor proportion: This ratio will be used to cap the fund allocation to any specific vendor to ensure fair distribution.
Enterprise Preference: This will be an extra weightage factor in case the enterprise have a segmentation of vendors in tiers. External Factor: This complicated variable takes into account factors like seasonality of demand, macroeconomic variables (e.g. demonetization, inflation, and the like.) to arrive at certain predictions which can affect the discounting rate materially.

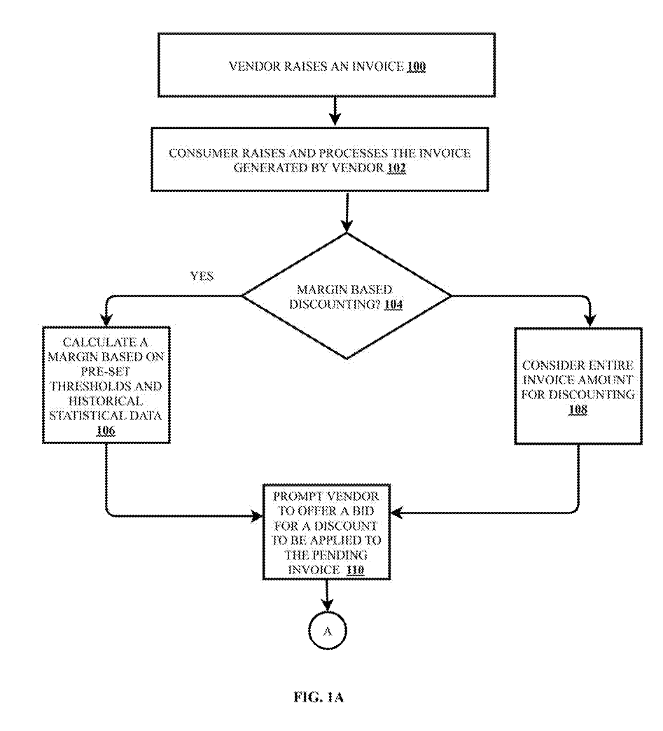

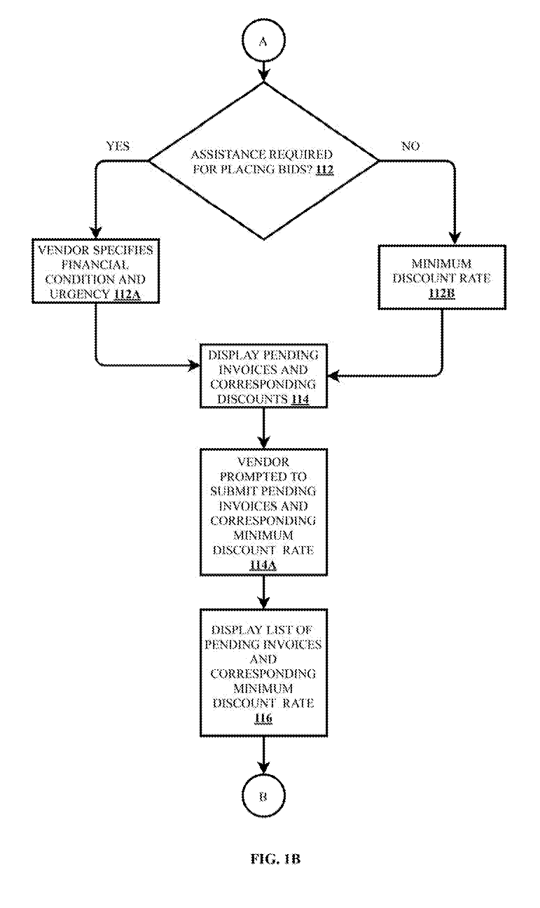

Referring to FIG. 1A, FIG. 1B and FIG. 1C in combination, there is shown a flowchart illustrating the steps involved in the method for dynamically determining a discount rate to be applied to a pending invoice, in accordance with the present disclosure. At step 100, a vendor raises an invoice in return for selling his goods and/or offering his services to a consumer. At step 102, the consumer processes the invoice generated by the vendor. At step 104, it is determined whether margin based invoice discounting procedure is applicable. The flow is directed to step 106 in the event that a margin based invoice discounting procedure is desired At step 106, a margin corresponding to the invoice is calculated based on pre-set thresholds and historical statistical data, and the invoice amount minus the margin is considered for discounting. At step 110, the vendor is prompted to offer a bid for a discount to be applied on to the pending invoice in exchange for an early payment. At step 104, alternatively, if it is determined whether margin based invoice discounting procedure is not applicable, then the flow is directed to step 108 where the entire ‘invoice amount’ is considered for discounting, and from step 108 the flow is directed to step 110.

Subsequently, at step 112, the vendor is prompted for assistance in terms of placing bids including discounts against an early payment of a pending invoice. If the vendor expresses his willingness to receive assistance in terms of placing bids, then at step 112A, the vendor is prompted to specify his financial condition and his urgency in terms of receiving an early payment. Subsequently, at step 114 the vendor is shown a list of pending invoices and entered discount rates, and at step 114A the vendor is further prompted to submit the pending invoices along with the corresponding discount rates. However, at step 112, if the vendor does not opt for assistance in terms of placing bids including discounts against an early payment of a pending invoice, then the flow is directed to step 112B where a minimum discount rate applicable to a pending invoice is calculated based on the vendor's profile and is displayed to the vendor. Subsequently, the flow is directed from step 112B to step 114 where the vendor is shown a list of pending invoices and at step 114A prompted to submit the pending invoice and the corresponding minimum discount rate. At step 116, the consumer is displayed a list of submitted invoices and the corresponding (applicable) discount rates. At step 118, the consumer is provided with the option of accepting the bids either manually or automatically. In the event that the consumer chooses to accept the bids manually, the flow is diverted to step 118A where a list of bids corresponding to pending invoices (submitted by vendors) is displayed to the consumer, and the consumer is prompted to consider each of the bids. However, at step 118, if the consumer opts for automatic determination of appropriate bid and selection thereof, then the flow is redirected to step 118B at which predetermined parameters corresponding to the consumer, such as current liquidity status, expected discount rate, discount rates currently offered by the way of bids, are considered to determine the most appropriate bid indicative of most appropriate discount rate (to be applied onto a pending invoice). Subsequently, at step 120, the consumer is prompted to accept the bid indicating the most appropriate discount rate and process the pending invoice on the basis of the said most appropriate discount rate.

### TECHNICAL ADVANTAGES

The technical advantages envisaged by the present disclosure include realization of a system and method that enables vendors to offer a dynamic discount on the pending invoices, based on their (vendors') financial needs and requirements, and further based on the number of days remaining for payment and the competing bids generated by other vendors. The system and method also provides for comparatively faster processing of invoices. Further, the system and method also enables consumers to selectively approve the pending invoices based on the availability of funds, the relationship between the consumer and each of the vendors, and the expected returns (discount rate offered by each of the vendors). The system provides vendors the option of securing an early payment in return for offering a discount—which is calculated dynamically based on a plurality of predetermined parameters—to the consumer.

The system further enables consumers to consider individual bids and make informed choices about accepting the bids, based on the discounts offered by each of the bids. The system envisages margin based discounts in return for early settlement of pending invoices. Further, the system provides recommendations/suggestions to consumers about accepting or rejecting each the bids, based on the financial needs specified by the vendors, bidding patterns of the vendors, and the like. The system takes into consideration the financial requirements of the vendor and the urgency associated with each of the invoices/bids submitted by the vendor, to decide upon the appropriate discount amount to be offered to a consumer as a bid for prompting the consumer to offer an early payment.

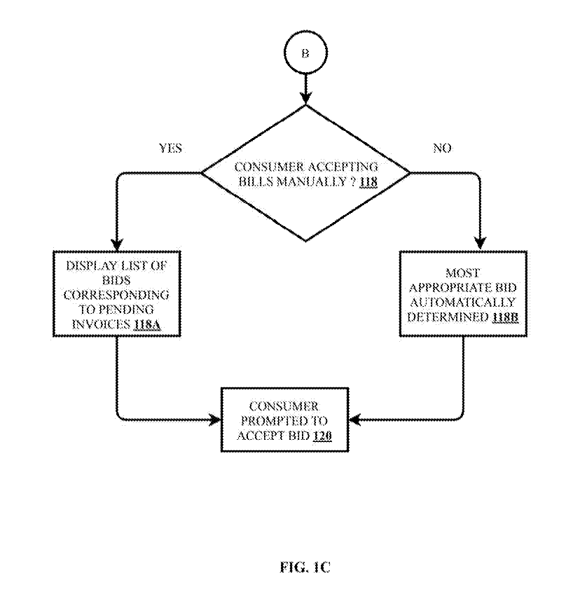

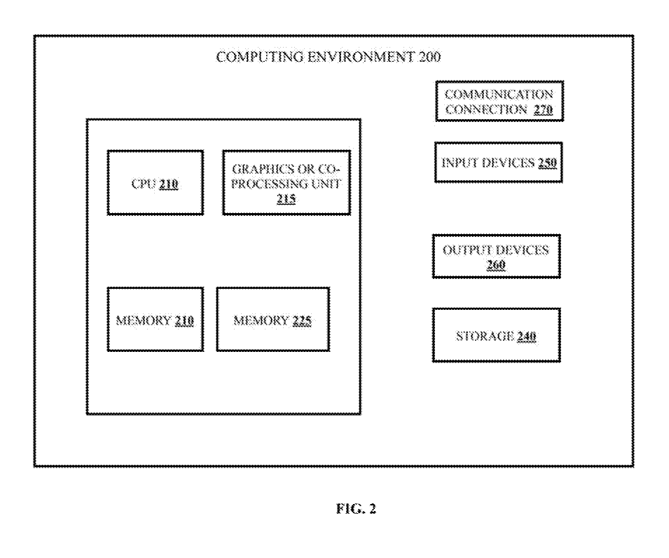

FIG. 2 depicts a generalized example of a suitable computing system 200 in which the described innovations may be implemented. The computing system 200 is not intended to suggest any limitation as to scope of use or functionality, as the innovations may be implemented in diverse general-purpose or special purpose computing systems.

With reference to FIG. 2, the computing system 200 includes one or more processing, units 210, 215 and memory 220, 225. In FIG. 2, this basic configuration 1130 is included within a dashed line. The processing units 210, 215 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 2 shows a central processing unit 210 as well as a graphics processing unit or co-processing unit 215. The tangible memory 220, 225 may be volatile memory (e.g., registers, cache, RAM), non-volatile memory (e.g., ROM, EEPROM, flash memory, etc.), or some combination of the two, accessible by the processing unit(s). The memory 220, 225 stores software 280 implementing one or more innovations described herein, in the form of computer-executable instructions suitable for execution by the processing unit(s).

A computing system may have additional features. For example, the computing system 200 includes storage 240, one or more input devices 250, one or more output devices 260, and one or more communication connections 1170. An interconnection mechanism (not shown) such as a bus, controller, or network interconnects the components of the computing system 200. Typically, operating system software (not shown) provides an operating environment for other software executing in the computing system 200, and coordinates activities of the components of the computing system 200.

The tangible storage 240 may be removable or non-removable, and includes magnetic disks, magnetic tapes or cassettes, CD-ROMs, DVDs, or any other medium which can be used to store information in a non-transitory way and which can be accessed within the computing system 200. The storage 240 stores instructions for the software 280 implementing one or more innovations described herein.

The input device(s) 250 may be a touch input device such as a keyboard, mouse, pen, or trackball, a voice input device, a scanning device, or another device that provides input to the computing system 1100. For video encoding, the input device(s) 250 may be a camera, video card, TV tuner card, or similar device that accepts video input in analog or digital form, or a CD-ROM or CD-RW that reads video samples into the computing system 200. The output device(s) 260 may be a display, printer, speaker, CD-writer, or another device that provides output from the computing system 200.

The communication connection(s) 270 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### EXAMPLE 7—IMPLEMENTATIONS

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer implemented method to determine and accept discount for a plurality of pending invoices, the method comprising:
receiving, by a processor of the computer, a vendor request to initiate a bidding session to place a bid for earlier processing of the plurality of pending invoices by a consumer;
based on the received vendor request, determining a discount for each of the plurality of invoices based on at least one of a vendor information, the consumer information, and a bidding pattern in previous session;
displaying, at a user interface of the computer, the plurality of invoices and the determined discount corresponding to the plurality of pending invoices; and
auto-selecting one or more pending invoices from the plurality of pending invoices based on at least one of the vendor information, the consumer information, and the bidding session specific information.

2. The computer implemented method according to claim 1, wherein determining the discount comprises:
determining, by the processor of the computer, an urgency of payment for the vendor; and
based on the determined urgency, determining the discount for each of the plurality of invoices.

3. The computer implemented method according to claim 2, wherein auto-selecting the one or more invoices comprises:
determining, by the processor of the computer, whether the vendor having urgency of the payment has alternate mechanism for discounting the invoice; and
based on the determination, de-prioritizing the bid of the vendor during the auto-selection.

4. The computer implemented method according to claim 1, wherein determining the discount comprises:
determining, by the processor of the computer, the consumer liquidity and the consumer base rate.

5. The computer implemented method according to claim 1, wherein determining the discount comprises:
determining a discount provided by one or more other vendors for their corresponding invoices.

6. A computer system to determine and accept discount for a plurality of pending invoices, the system comprising:
a memory storing a plurality of instruction; and
a processor to execute the instructions stored in the memory to:
receive a vendor request to initiate a bidding session to place a bid for earlier processing of the plurality of pending invoices by a consumer;
based on the received vendor request, determine a discount for each of the plurality of invoices based on at least one of a vendor information, the consumer information, and a bidding pattern in previous session;
display the plurality of invoices and the determined discount corresponding to the plurality of pending invoices; and
auto-select one or more pending invoices from the plurality of pending invoices based on at least one of the vendor information, the consumer information, and the bidding session specific information.

7. The computer system according to claim 6, further executing instructions to:
determine an urgency of payment for the vendor; and
based on the determined urgency, determine the discount for each of the plurality of invoices.

8. The computer system according to claim 7, further executing instructions to:
determine whether the vendor having urgency of the payment has alternate mechanism for discounting the invoice; and
based on the determination, de-prioritize the bid of the vendor during the auto-selection.

9. The computer system according to claim 6, further executing instructions to:
determine the consumer liquidity and the consumer base rate.

10. The computer system according to claim 6, further executing instructions to:
determine a discount provided by one or more other vendors for their corresponding invoices.
